(19) United States
(12) Patent Application Publication
(10) Pub. No.: US 2004/0244901 A1
(43) Pub. Date: Dec. 9, 2004

(54) Method and apparatus for lenticular printing

(75) Inventors: Gabriele M. Trapani, Pueblo, CO (US); Brian Ulricksen, Denver, CO (US)

Correspondence Address: SHERIDAN ROSS PC, 1560 BROADWAY, SUITE 1200, DENVER, CO, 80202

(73) Assignee: Magicolor Graphics 2000, Inc.

(21) Appl. No.: 10/769,442

(22) Filed: Jan. 30, 2004

Related U.S. Application Data
(63) Continuation of application No. 10/103,549, filed on Mar. 20, 2002, now abandoned.
(60) Provisional application No. 60/278,653, filed on Mar. 20, 2001.

(51) Int. Cl. B31F 1/00; B65C 1/00; B29B 7/00

(52) U.S. Cl. 156/219; 156/443; 156/500

(57) ABSTRACT

An apparatus and method for forming a lenticular optical system is provided in which a composite image is viewable through a molded lens from a first angle and an object or image placed at a preselected distance beneath the composite image is viewable from a second angle. The apparatus of the present invention provides for registration of the lenticular lenses with the printed image when the lenses are formed.

### CROSS REFERENCE TO RELATED APPLICATIONS

The present application is a continuation of U.S. patent application Ser. No. 10/103,549 filed Mar. 20, 2002 entitled “METHOD AND APPARATUS FOR LENTICULAR PRINTING”, which claims the benefit of U.S. Provisional Patent Application No. 60/278,653 filed on Mar. 20, 2001, and entitled “METHOD AND APPARATUS FOR LENTICULAR PRINTING.” The disclosure of the prior applications are incorporated herein by this reference in their entirety.

### FIELD OF THE INVENTION

The present invention relates to a lenticular optical system and method through which various composite images can be viewed, more particularly to the printing of thin sheet lenticular lens materials, and even more particularly to a system which forms a lenticular lens in registration to the underlying image and an apparatus for carrying out this method.

### BACKGROUND OF THE INVENTION

Lenticular lenses are well known in the art for use in optical systems to produce various types of optical effects. Lenticular optical systems known in the background art generally include a transparent sheet having a planar surface on one side thereof and on the other side, a series of longitudinal convex ridges forming a multi-lenticular system of convex lenses. A print sheet is typically disposed behind the lens adjacent to the planar surface. The print sheet contains a series of spaced image lines constituting a dissection or breakup of a master image. The series of spaced image lines are optically related with respect to the lenses. When viewed from a first position a first series of image lines are visible and display a first composite image. When viewed from a second position a second series of image lines are visible and display a second composite image.

In addition, further advances in lenticular optical systems have resulted in the increase in the number of observable frames available. The increase in observable frames has made lenticular animation possible. Therefore, as the observer moves relative to the lenticular viewing screen, a series of pictures come successively into view thus creating the impression of continuous changes in the phases of motion. Accordingly, current lenticular optical technology is capable of producing a composite image of a series of N scenes resulting in an animation picture when viewed properly at successive viewing angles. In addition, such technology may be used to display a wide variety of useful information, such as account information.

Three dimensional (3-D) effects can also be created using lenticular technology. Three dimensional printing uses a layering of multiple illustrations or photographic elements to create a three dimensional perception. By using advanced computer technology to generate subtle differences in dot patterns, lenticular technology creates a perception of motion and depth.

The original lenticular image can be created photographically, electronically or by a combination of both. Images can be reproduced using photo-sensitive materials, printed by lithographic means or by other means of printing or transfer of inks and dyes.

The quality of the perceived images is affected, in large part, by the relationship between the lenses and the underlying image. The more precisely the image is located under respective lenses, the higher quality of the final image. Similarly, the more closely parallel the underlying image and the respective lenses, the higher degree of quality of the final image. For example, if the lenses of a lenticular system are precisely located above the underlying image and perfectly parallel, a two image lenticular system can produce the complete cancellation of the first image when the second image is viewed. That is to say, the first image is not at all visible and therefore does not interfere with the viewing of the second image.

Lenticular lenses and lenticular materials have a wide variety of uses, particularly for advertising purposes. To date, lenticular materials have been used on cereal boxes and other packaging to promote movies, for example, and even business cards.

It is therefore desirable to provide a process to manufacture lenticular materials, including identification cards, credit cards, smart-chip cards, security cards, etc. economically while maintaining desired properties of an optical system, combined with the properties of a conventional card.

### SUMMARY OF THE INVENTION

It is therefore an aspect of the present invention to provide an improved eye-catching card with either multiple switching images or a 3-D image. It is a further aspect of the present invention to provide a product that can be used as a credit card, security card, pass card, or identification card with relatively good counterfeit deterrent.

It is yet a further aspect of the present invention to be able to compile twice the amount of visual information as is carried by any conventional card by means of the two image switch, or multiple image switch, of the present invention.

Yet a further aspect of the present invention is to present a more dynamic image by means of the 3-dimensional image property of the lenticular optical system.

Yet another aspect of the present invention is to provide the capability of the card to be used at a bank teller machine and also to have a smart chip installed into it.

It is yet another aspect of the present invention to provide a method of registration between a lenticular lens and an underlying image to provide a high quality final image when viewed through the lenticular lens.

These and other aspects of the present invention are fulfilled by providing an apparatus for making a lenticular product from a plurality of sheet materials, comprising a first plate having a plurality of lens grooves and a plurality of registration pins or guides or some type of mark or guide, such as a guide edge or corner, other known registration means, etc. (hereinafter “guides”) so that the sheet is properly registered with respect to the lenticules. The apparatus may also include a plurality of pin cavities in the second plate for correspondingly receiving said plurality of registration pins or guides and may also include a biasing means behind said registration pins or guides to allow the pins to retract into said pin cavities. The second plate of the apparatus may also include a plurality of apertures for receiving said registration pins or guides. Those apertures may be viewed as alignment holes and may be of many various shapes and configurations as found, elongated, square, triangular, etc.). Additionally, the first and/or second plates of the apparatus may include a heating element and/or a cooling element for elevating and reducing the temperature of the plates and thus, the materials adjacent thereto, including air or liquid emitting devices to achieve desired heating or cooling.

Thus in one aspect of the present invention, a method adapted for forming a lenticular product from a plurality of sheet materials is provided comprising the steps of: providing a first sheet material; providing a second sheet material having an image printed on one side, said image including a plurality of registration marks in a predetermined relationship with said printed image; removing a portion of said second sheet located within said plurality registration marks to provide a plurality of registration holes in said second sheet; providing a lenticular forming die having a first plate comprising a plurality of lens grooves and a plurality of registration pins or guides and a second plate; placing said first sheet on said first plate; placing said second sheet on said first plate such that said registration pins or guides are received into said second sheet registration holes; bringing said second plate into contact with said first plate; and heating said first sheet and said second sheet to a desired temperature for a period of time to substantially fuse said first sheet with said second sheet and to form a plurality of lenticular lenses on said first sheet.

### BRIEF DESCRIPTION OF THE DRAWINGS

FIG. 1 is a cross-sectional elevation view of a typical lenticular optical system;

FIG. 2a is an exploded front elevation view of one embodiment of the apparatus for forming a lenticular product of the present invention;

FIG. 2b is an exploded front elevation view of another embodiment of the apparatus for forming a lenticular product of the present invention;

FIG. 2c is an exploded front elevation view of still another embodiment of the apparatus for forming a lenticular product of the present invention;

FIG. 3 is top plan view of one embodiment of the lenticular die plate of the present invention;

FIG. 4 is a side elevation view of the lenticular die plate shown in FIG. 2a-c;

FIG. 5 is a bottom plan view of one embodiment of the punch plate of the present invention; and

FIG. 6 is a perspective view of one embodiment of a lenticular card of the present invention.

FIG. 7 is a side view of one embodiment of the present invention with a pin extending through plates that line up the plates along one or more pins. The pins can be about 5-6 inches high and can preferably accommodate between 1 and 20 sheets at a time.

FIG. 8 shows a side view of yet another embodiment of the invention with extended registration pins or guides.

### DETAILED DESCRIPTION

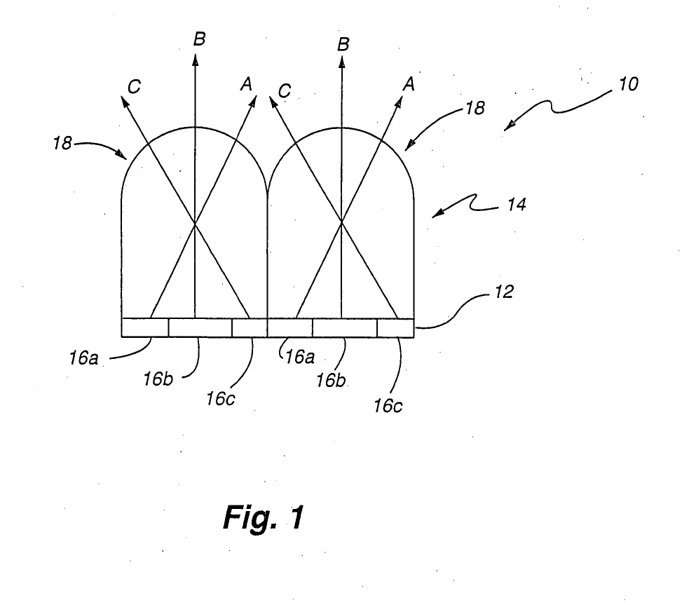

FIG. 1 shows a typical lenticular optical system 10 in cross-sectional elevation view. The lenticular optical system 10 includes a substrate 12 and a lens body 14. The substrate 12 includes a plurality of alternate series of printed images 16. The lens body 14 is a transparent material having a series of convex ridges, or lenticular lenses 18, formed thereon. The series of printed images 16a, 16b, and 16c are optically related to corresponding lenticular lenses 18 such that the printed images are alternately visible to an observer based upon the angular displacement of the lenticular optical system 10. For example, when the observer views the lenticular optical system 10 from a first position A, the optical lines of sight are refracted by the lenticular lenses 18 toward the first printed image 16a. Similarly, when the observer views the lenticular optical system 10 from a second position B, or third position C, the lines of sight are correspondingly refracted by the lenticular lenses 18 toward the second printed image 16b or third printed image 16c. If the printed images 16 are properly aligned with the lenticular lenses 18, the observer sees only one image. This result is often referred to as complete cancellation. Higher quality lenticular systems correspond to more complete cancellation. Although this discussion describes three separate printed images, it is understood that improvements in printing processes have enabled lenticular systems to comprise more than two or three printed images. Accordingly, to the extent the diagrammatic depiction of the lenticular system of FIG. 1 is limited to three printed images, the present invention contemplates the use of a large number of printed images where desired and is not limited to three printed images (e.g. 4, 5, 6, etc., printed images can be used).

In order to obtain the highest quality image possible, complete cancellation of alternate images is desired. In order to reach this goal, or otherwise approach it as near as possible, it is necessary to properly align, or register, the printed image with the lenticular lenses. The present invention obtains this goal by providing an apparatus and method for forming a lenticular optical registration system including a novel registration system.

One of the possible uses of lenticular lenses and lenticular lens materials is in the production of security cards. Security cards, including but not limited to credit cards, automatic teller machine (ATM) cards, long distance calling cards, etc. are commonly used for transacting day-to-day business. These cards and identification means can employ lenticular lens materials to include in various images such information as account numbers, card holder information, or other security features. In order to satisfy the security concerns as well as the aesthetic features of these cards, business owners as well as consumers demand a high quality product. This demand for high quality product requires the production of higher quality final images of lenticular lenses.

The manufacturer of such cards must comply with the requirements of International Standard (ISO) 7810. ISO 7810 sets forth the standards for physical characteristics of identification cards including credit cards and the like. Among these physical characteristics are dimensions of the card types, product card materials of construction and special characteristics regarding magnetic strips and surface distortions. To the extent ISO 7810 is relevant to this application, it is herein incorporated by this reference.

The present invention utilizes advancements in printing processes to register the printed images with the lenticular lenses during formation of the lenses. In particular, a first sheet is provided with a series of printed images. Additionally, during the printing process, at least one registration mark is printed on the first sheet. With current printing technology, the registration marks may be precisely located relative to the printed images. Once the printing process is complete, a portion of the first sheet within each registration mark is punched to provide a registration hole. The registration holes, and thus the printed images, may then be registered with a die for forming the lenticular lenses prior to the formation of the lenses. A lenticular die is provide to accomplish the registration.

Alternatively, the registration holes may be formed in the printed sheet prior to printing. In this embodiment the printing process is registered by an apparatus or method known in the art such that the printing of the image is in a known relationship to the pre-formed registration hole. As described more fully below, the registration holes may also be registration notches (of any various shape or configuration) to correspond with registration blocks, rather than a registration pin.

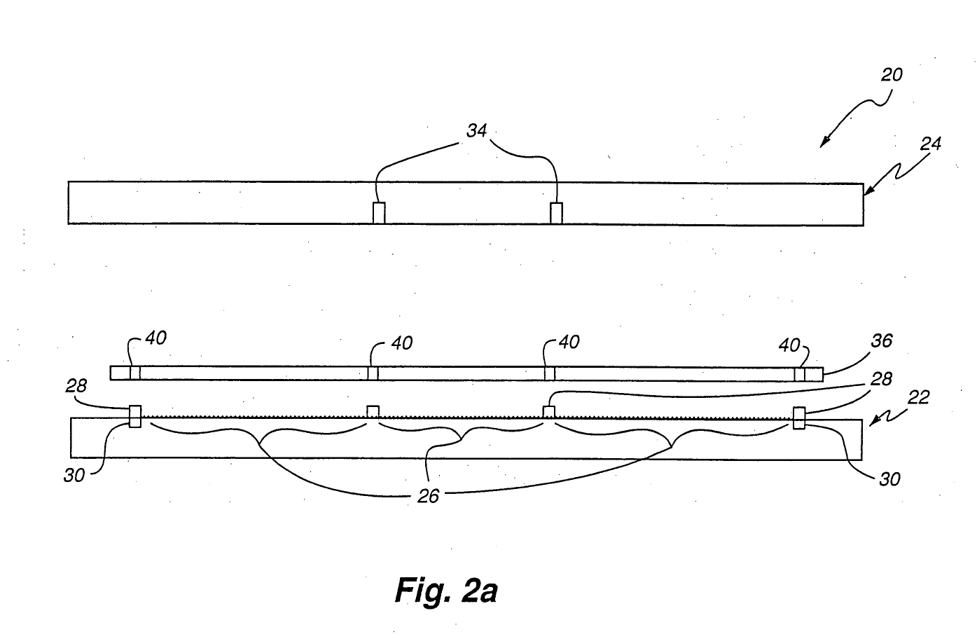

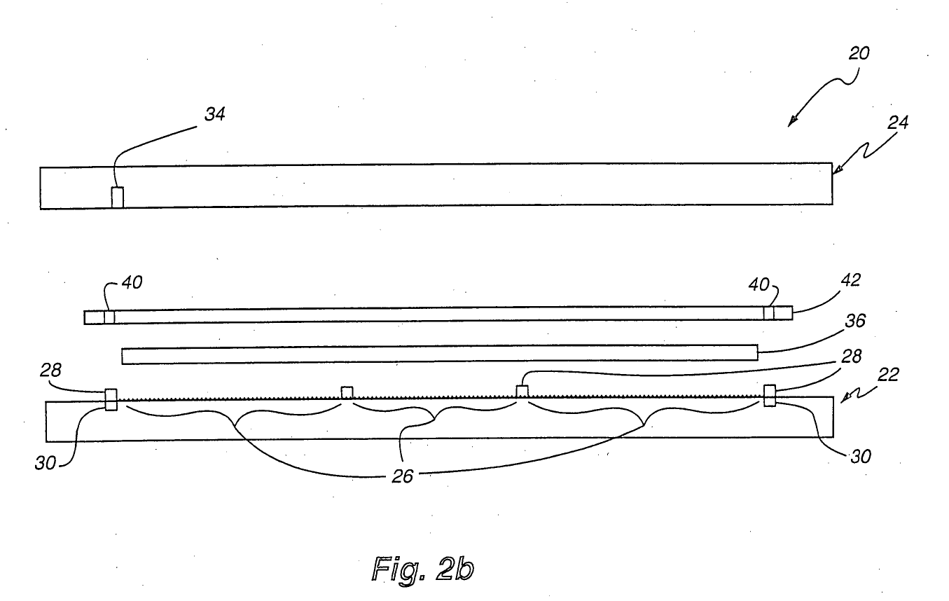

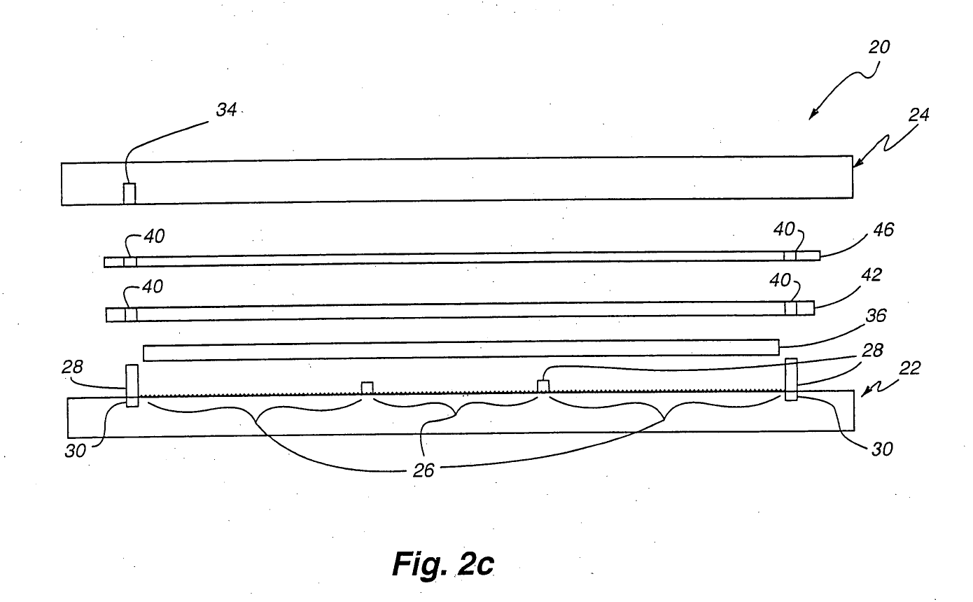

With reference to FIG. 2a, one embodiment of the lenticular die 20 is shown in exploded front elevation view. The lenticular die 20 is comprised of a die plate 22 and a punch plate 24. The die plate 22 includes a plurality of lenticular grooves 26 for forming the lenticular lenses 18 on sheet of material. Die plate 22 also includes a plurality of registration pins 28 or guides. The die plate 22 is constructed such that the lenticular grooves 26 are in a known relationship with the registration pins 28 or guides. The registration pins 28 or guides are mounted over or within a pin cavity 30. Alternatively, the punch plate 24 may include a plurality of pin apertures 34 corresponding to the registration pins 28 or guides of the die plate 22. In this alternative embodiment, the registration pins 28 or guides may be received into the pin apertures 34 when the die plate 22 and the punch plate 24 are brought together.

An alternative registration mechanism may be used to register the printed image 16 with the lenticular grooves 26. For example, registration blocks (not shown) may be used in lieu of registrations pins 28. The registration blocks may be formed of a selected geometry adapted to receive a corresponding geometry cut in the printed sheet 16. For example, triangular notches may be cut into the printed sheet 16 and inserted into the lenticular die 20 to mate with the corresponding geometry of a registration block. In an alternative embodiment, the registration block can be received into block apertures in the punch plate 24, or may be located beyond the edges of the die plate.

The lenticular die 20 of the present invention may also include additional features not shown in the figures. For example, the lenticular die 20 may include one or more heating elements. The heating elements transfer heat to the die plate 22, the punch plate 24 or both, to elevate the temperature of the sheets as described below. The heating elements may generate the heat to be transferred by electricity, steam, or in any other known manner. For example, the heating element may be one or more electric heating elements or cartridges placed in the body of either (or both) the die plate 22 or the punch plate 24. Alternatively, an array or series of channels may be provided in the body of either the die plate 22 or the punch plate 24 (or both) for use with steam or other heat transfer medium to heat the plates. Additionally, the die plate 22 or the punch plate 24, or both, may include a series of channels formed therein for the circulation of chilled water or other heat transfer medium to form a cooling element. The circulation of chilled water or other heat transfer medium allows the rapid cooling of the plates 22 and 24 for further handling of the lenticular product 38. Preferably, for the sake of efficiency, the heating cycle and the cooling cycle do not occur simultaneously. That is, the heating cycle is stopped prior to the start of the cooling cycle. The lenticular die 20 may also include guide posts to maintain the relative position of the die plate 22 to the punch plate 24 as the lenticular die 20 is opened and closed.

With continued reference to FIG. 2a, in order to form a lenticular product, a lens sheet 36 is inserted into the lenticular die 20 onto the die plate 22. The lens sheet 36 is preferably made of a transparent material to enable a person to view a printed image 16 through the lens.

In a preferred embodiment, cards manufactured using the present invention will not be completely lenticular to its edges, but rather, will have a flat, non-lenticular border. This is so to accommodate laser reading systems which may reject a lenticular card because light is not completely absorbed as it would be with a flat surface. If light is reflected, the card may be perceived as being bent by the laser reading apparatus. Thus, in one embodiment of the invention, the cards made have lenticular elements within the interior, but not on the exterior thereof.

Several alternative methods are available to form a lenticular product 38 in the lenticular die 20 with the lens sheet 36. For example, in a first embodiment shown in FIG. 2a, the lens sheet 36 may have an image printed on the side of the lens sheet 36 placed away from the die plate 22. In this embodiment, the printed image 16 must be printed as a “mirror image” of the desired image as it will be viewed from the side of the lens sheet 36 placed adjacent to the die plate 22. The printed image 16 includes one or more registration marks. The registration mark is punched, or otherwise cut, to remove the portion of the lens sheet 36 within the registration mark to create a registration hole 40. The lens sheet 36 is placed within the lenticular die 20 onto the die plate 22 such that the registration holes 40 are received by the registration pins 28 or guides. The die plate 22 is designed such that the lenticular grooves 26 correspond to the registration pins 28 or guides in such a way as to precisely correspond with the relationship between the registration holes 40 of the printed image 16. The registration holes 40 similarly correspond precisely with the printed image 16. Thus, the forming of the lenticular lenses 18 is directly tied to the printed images 16 and thus a precise registration between the two may be obtained.

Once the lens sheet 36 is properly placed on the die plate 22, the punch plate 24 is brought into contact with the die plate 22. Either the registration pins 28 or guides retract into the die plate 22, or the punch plate 24 has pin apertures 34 to receive the registration pins 28 or guides such that the punch plate 24, the lens sheet 36 and the die plate 22 are in continuous contact with the respective adjacent elements. The remaining steps to the process will be explained below with respect to this and other embodiments.

In an alternative embodiment shown in FIG. 2b, a lens sheet 36 with no printing may be placed on the die plate 22. Next, a print sheet 42 is placed on the die plate 22. In this embodiment, the print sheet 42 has an image printed on one side including registration marks. As above, the registration marks are punched, or otherwise cut, to remove the portion of the print sheet 42 within the registration marks to create a registration hole 40. The print sheet 42 is placed upon the die plate 22 such that the registration pins 28 or guides are received by the registration holes 40. In this embodiment, the lens sheet 36 does not require registration holes since the alignment of the lenticular grooves 26 is only necessary with the printed image 16. The lens sheet 36 should, however, fit within the area between registration pins 28 or guides to avoid interference between the registration pins 28 or guides and the registration holes 40 provided in the print sheet 42. If the lens sheet 36 is larger than the area defined by the registration pins 28 or guides, holes or notches must be provided in the lens sheet 36 to avoid this interference. It is noted that precise location of the lens sheet 36 is not critical in this embodiment since the lenticular lenses are formed in relationship to the die plate 22, its registration pins 28 or guides, and the printed image 16 located on print sheet 42. As above, the die plate 22 and the punch plate 24 are brought into contact such that the die plate 22, the lens sheet 36, the print sheet 42, and the punch plate 24 are in substantially continuous contact. Again, the remaining steps of the forming process are described in more detail below.

In a third possible embodiment shown in FIG. 2c, a third sheet may be provided, for example, a magnetic strip sheet 46 for making a secure card (e.g., an overlay sheet contains a magnetic strip), or credit card-type, lenticular product. The magnetic strip sheet 46 includes registration holes 40 to properly align the magnetic strip relative to the final product. The magnetic strip sheet 46 is inserted into the lenticular die 20 nearest the punch plate 24 such that the registration holes 40 receive the registration pins 28 or guides prior to closing the lenticular die 20. Alternatively, the magnetic strip sheet can be tacked or otherwise oriented onto sheet 42. Alternatively, the third sheet may include a computer chip, a smart chip, or other device for storing information. The third sheet may also include a signature strip or may simply be another layer of material. If the third sheet does not contain a magnetic strip or other component which requires precise location, the addition of registration holes 40 in the third sheet may be omitted.

In each of the above, and other, embodiments, once the die plate 22 is brought into contact with, or separated only by the inserted sheets from, the punch plate 24, sufficient pressure is applied so that the lenticular die provides the proper constraints to form the lenticular product. Typically, the die plate 22 and the punch plate 24 are subjected to an effective pressure, typically between about 0.1 ton per square inch (tons/sq. in.) to about 0.2 tons per square inch and, more typically, between about 0.14 tons per square inch and about 0.17 tons per square inch. For example, about 25 tons of pressure is preferably applied to a 12×12 sheet.

Once the lenticular die 20 is closed, the sheets are heated to a desired temperature for a specified time period to form the lenticular lenses and, if multiple sheets are provided, to fuse the lens sheet 36, the print sheet 42, and the possible third sheet into a single lenticular product 38. Typically, the components are heated to a temperature from about 250° F. to about 450° F and, more typically, from about 290° F. to about 350° F., depending upon the sheet material used. Additionally, the die plate 22 and/or the punch plate 24 may be heated prior to the placement of the sheets within the lenticular die 20. The sheets in the lenticular die 20 are typically held at the desired temperature for a time period from about 30 seconds to about 10 minutes and, more typically, from about 3 minutes to about 8 minutes and, even more typically, from about 4 minutes to about 6 minutes, depending upon the number of sheets and the materials used. Obviously, however, heating times will vary depending upon what type and nature of materials are used and what heating methods/devices are employed.

The materials used for the sheets can be any material which is capable of heat sealing. Typical materials, and those required by ISO 7810, include polyvinyl chloride (PVC), polyvinyl chloride acetate (PVCA), or materials having equal or better performance such as polyesters, polyethylenes, and polycarbonates. Preferably, the sheet material is a polyvinyl chloride. More preferably, at least for use in identification cards, the sheet material is a polyvinyl chloride known by the trade name Mirrex 1025. The first sheet, i.e., the sheet upon which the lenticular lenses 18 are formed must be clear, or at least transparent enough, to allow a viewer to see the image behind the lenses 18. Other sheets, if included, may include pigments to provide a opaque color to the sheet. Preferably, the opaque color is white, however other pigments may be used to provide a sheet of virtually any color or tint.

The thickness of the sheet materials employed may vary according to the desired lenticular product 38. However, for the creation of a lenticular product 38 which complies with ISO 7810, the required product thickness is 0.030 inch. In order to provide an ISO 7810 compliant product, the lens sheet 36 and print sheet 42 provided are typically between about 0.012 inch and about 0.018 inch and, more typically, between about 0.013 and about 0.017 inch and, preferably, 0.015 inch thick. If a magnetic strip sheet 46 is provided such that the lenticular product 38 has a data storage means, the lens sheet 36 and print sheet 42 provided typically have a thickness of between about 0.012 and about 0.016 inch and, more typically, between 0.013 and 0.015 inch and, preferably, 0.014 inch. The corresponding thickness of the magnetic strip sheet 46 typically has a thickness of between about 0.001 inch and 0.005 inch and, preferably about 0.002 inch. In any case, a clearance should be provided between the die plate 22 and the punch plate 24 substantially equal to the total thickness of the combined sheets.

A lenticular product 38 may also be created wherein the printed image 16 is on one side of a clear or other such translucent media such that the image 16 can be viewed from the opposite side of the print sheet 42. In this embodiment, only a single sheet thickness may be required to create the desired lenticular product thickness. To create a lenticular product 38 which complies with ISO 7810, a print sheet 42 material thickness in the range of 0.025 to 0.030 inch may be used. Alternatively, a print sheet 42 thickness in the range of 0.025 to 0.028 may be used in conjunction with an overlay. The overlay would essentially comprise a second sheet of material and have a material thickness of between 0.004 and 0.002 inch. The overlay may serve various purposes including protection of the printed image 16 from being damaged or may include a magnetic strip as described above. While a lenticular product 38 which complies with ISO 7810 is described, i.e., the final product thickness is approximately 0.030 inch, other thicknesses may be desirable for the final lenticular product 38. In these cases, the sheet material thicknesses selected may correspond with this desired thickness as well as other secondary sheet material such as a print sheet 42 or an overlay.

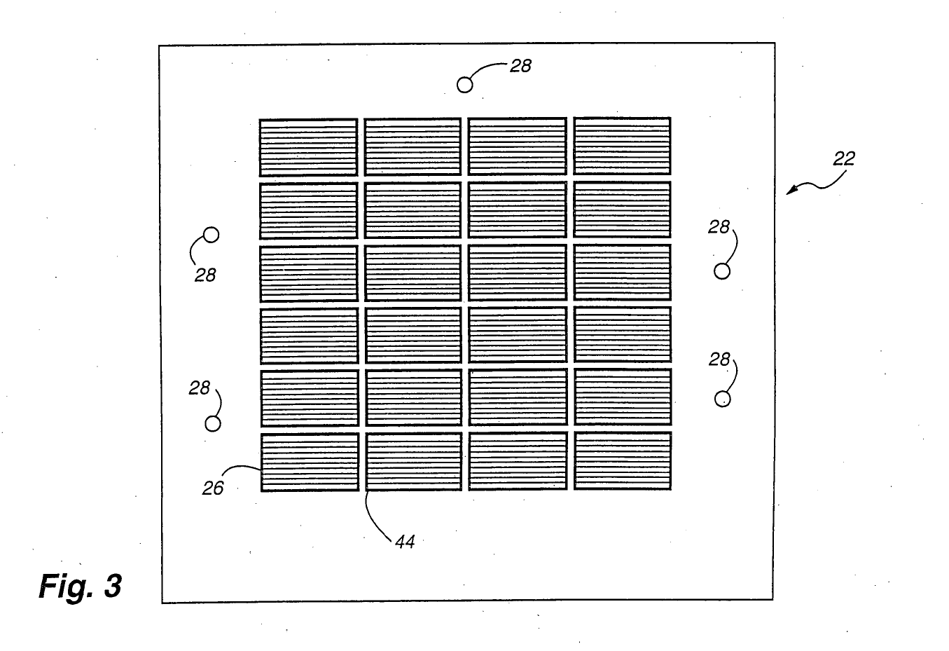

Referring now to FIG. 3, one embodiment of the die plate 22 of the present invention is shown in top plan view. The die plate 22 include registration pins 28 or guides and plurality of lenticular grooves 26. The lenticular grooves 26 of this embodiment are arranged in groups to form a four by six matrix. Thus, the die plate 22 of FIG. 3 is capable of forming twenty-four separate lenticular products 38 in a single operation. It is noted, however, that the arrangement of the lenticular grooves 26 may include a myriad of combinations of various group sizes or a single bed of lenticular grooves 26 to form a single lenticular product 38 in one operation.

In the embodiment shown in FIG. 3, lands 44 are provided around the circumference of the groups of lenticular grooves 26. These lands 44 form a substantially flat area on the lenticular product 38. The lands 44 may be used, for example, to form a border having no lenses around a lenticular product 38. This is useful in forming a card in compliance with ISO 7810. Cards manufactured in compliance with ISO 7810 are required to have a minimum border at the edges of the card.

The depth and spacing of the lenticular grooves 26 of the die plate 22 are selected according to the thickness of the lens sheet 36 and the distance to and arrangement of the printed image 16. The spacing of the lenticular grooves 26 directly correspond to the spacing of the lenticules, or lenses, on the lenticular product 38. Typically, the lenticular grooves 26 are machined into the die plate 22 such that the lenticular grooves 26 provide a lenticular product 38 with between about 10 and about 300 lenticules per inch (lpi). More typically, the lenticular grooves 26 will be arranged to provide a lenticular product 38 with between about 50 and about 120 lenticules per inch and, more typically, between about 50 and about 80 lenticules per inch.

The material of construction of the die plate 22 may essentially be any material which can be machined and also withstand the pressure and temperature requirements of the process without substantially being altered in form, e.g. deforming, bending, etc. Typically, the die plate 22 is constructed of a metal or metal alloy. In a preferred embodiment, the die plate 22 is constructed of a beryllium copper alloy. Copper is used to provide a desired heat transfer capability of the die plate 22. Beryllium is added to provide strength for machining of the die plate 22. The thickness of the die plate 22 may vary depending upon the parameters of the process. However, it is preferred to select the thickness of the die plate 22 to optimize strength while minimizing the necessary mass to be heated.

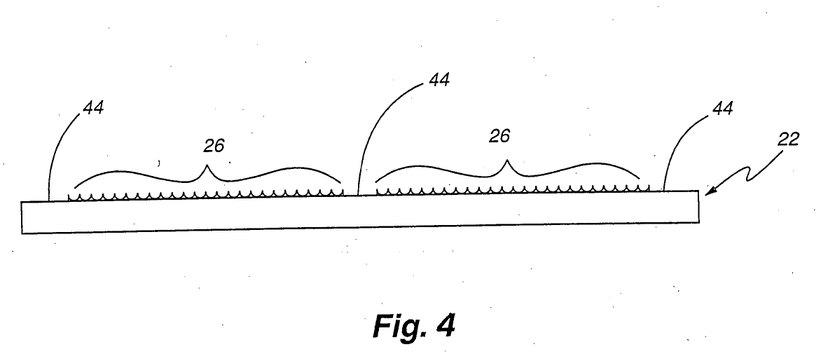

With reference to FIG. 4, a side elevation view of one embodiment of the die plate 22 is shown. The die plate 22 has a series of lenticular grooves 26 which form lenticular lenses 18 in the lens sheet 36 during the process described above. In the embodiment shown in FIG. 4, the lenticular grooves 26 are shown formed above the general surface of the die plate 22, while the lands 44 are created by the general surface of the die plate 22. In this embodiment, lenticular lenses 18 will be formed such that the upper surface of the lenticular lenses 18 will be substantially in the same plane as the lands 44. In this embodiment, a lenticular product 38 may be formed which complies with the minimum border mandate of ISO 7810.

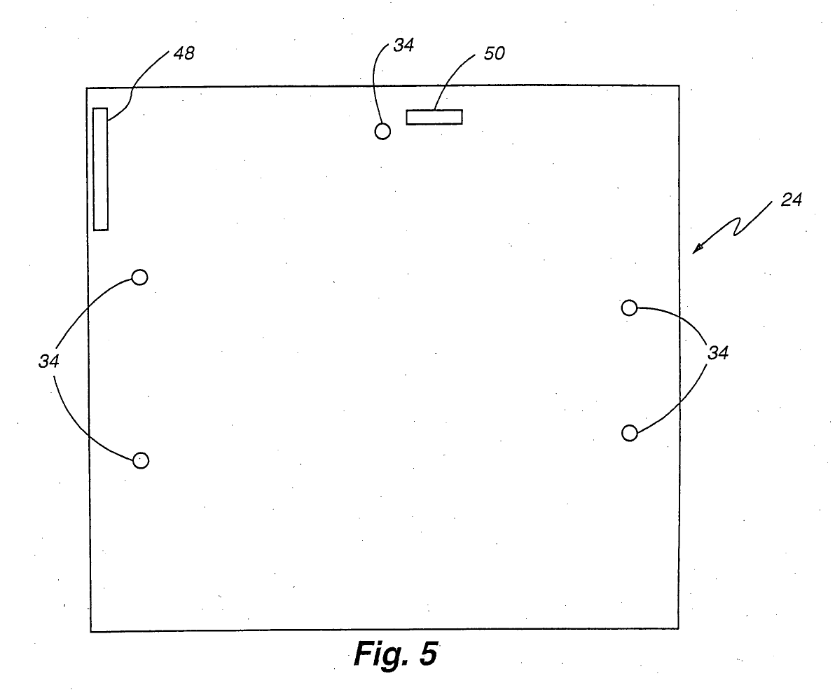

Referring now to FIG. 5, one embodiment of the punch plate 24 is shown in bottom plan view. As described above, the punch plate 24 may include pin apertures 34 for receiving the registration pins 28 or guides of the die plate 22 when the punch plate 24 and the die plate 22 are brought together. Additionally, the punch plate 24 may include guide rails 48 to approximately position the lens sheet 36 or print sheet 42 when those sheets are placed within the lenticular die 20. The guide rails 48 limit the insertion of a sheet, e.g., a lens sheet 36, to assist the operator in locating the registration pins 28 or guides or to ensure a sheet without registration holes 40 is appropriately located within the lenticular die 20. The punch plate or die plate may also have holes placed therein to accommodate multiple sheets and die plates being stacked on top thereof. The punch plate 24 may also include a gripper component 50. The gripper component 50 may be a recessed area on the surface of the punch plate 24 which allows the operator to grab a sheet, e.g., the print sheet 42, or the lenticular product 38 if the sheet or lenticular product 38 affixes itself to the punch plate 24.

The punch plate 24 may be constructed of essentially any material which can withstand the pressure and temperature requirements of the operation while maintaining a substantially planar surface in contact with the die plate 22 or the sheet materials. Typically, the punch plate 24 is constructed of a steel alloy, or other metal or metal alloy. In a preferred embodiment, the punch plate 24 is constructed of a chrome plated steel. The chrome plated steel improves the durability of the punch plate 24 and enhances the smoothness of the finish on the lenticular product 38 adjacent to the punch plate 24. The smoothness of the finish of the lenticular product 38 provides a shiny surface on that portion of the lenticular product 38.

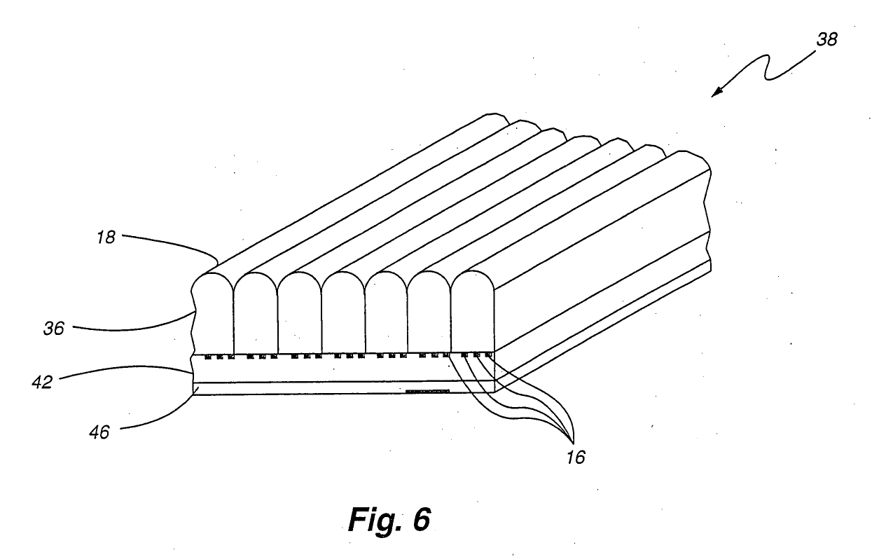

With reference to FIG. 6, one embodiment of a lenticular product 38 of the present invention is shown. The lenticular product 38 shown in FIG. 6 includes a lens sheet 36 with lenticular lenses 18 formed therein, a print sheet 42, and a magnetic strip sheet 46. With the use of the registration holes 40 and the registration pins 28 or guides, the lenses are formed directly above and parallel to the printed image 16. Additionally, the exact location of the magnetic strip may be ascertained by the use of registration holes 40 and registration pins 28 or guides in the magnetic strip sheet 46.

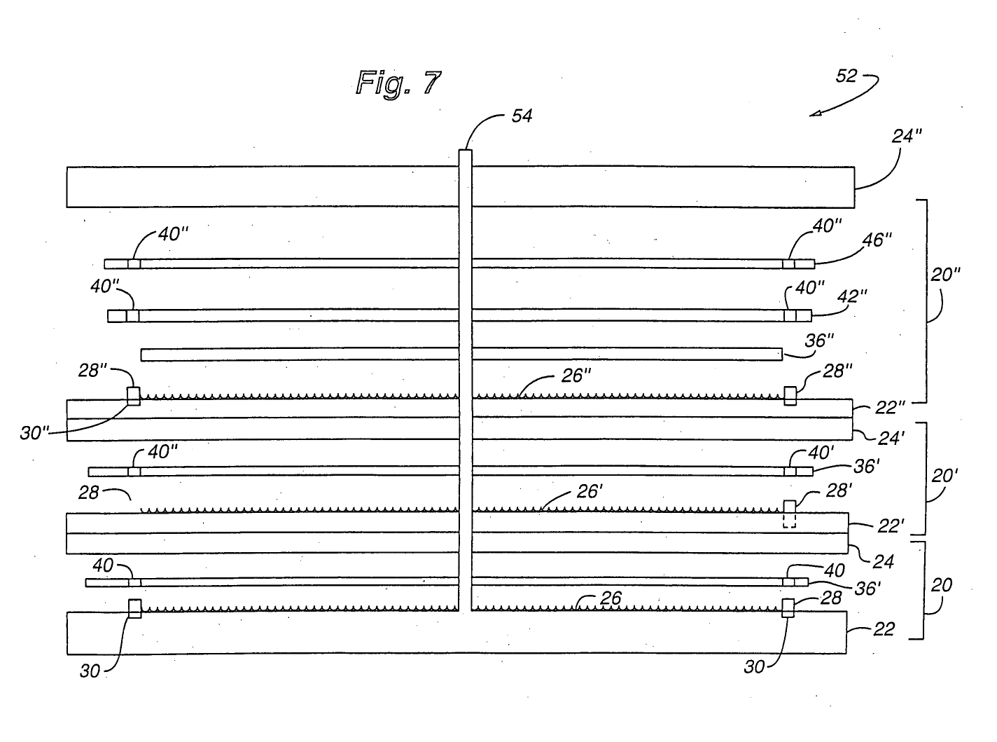

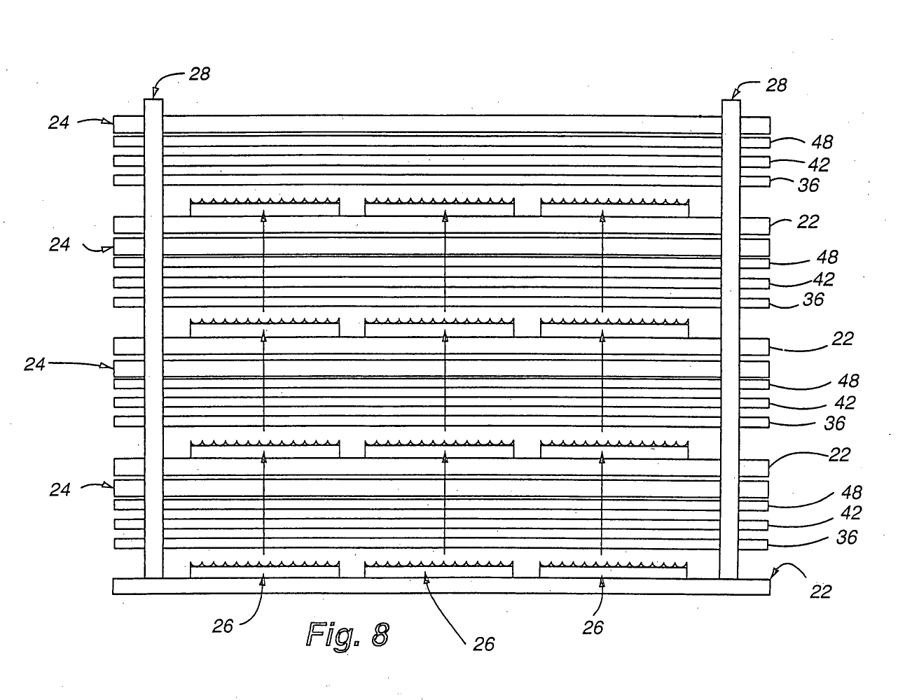

With reference to FIG. 7, an additional embodiment of a lenticular die 20 is shown. In this embodiment, it can be seen that a plurality of lenticular dies 20, 20′, 20″, etc. may be stacked upon one another to form a lenticular die assembly 52 such that a single press may be used to apply necessary pressure while utilizing the available vertical space in a press. In the embodiment shown, a common die pin 54 extends from the top punch plate 24″ to the bottom die plate 22. The common die pin or pins 54 allow registration between the punch plates 24, 24′, 24″, and die plates 22, 22′, 22″ as well as between individual lenticular dies 20, 20′, 20″. Each die pin can extend several inches to accommodate stacking of additional (preferably no more than about 20) die plates. It is understood, however, that additional embodiments of this arrangement are possible. For example, individual die pins (not shown) may extend only between a corresponding die plate 22 and the related die punch plate 24. Further, as shown in FIG. 7, the punch plate 24 of the first lenticular die 20 may be formed adjacent to or interconnected with the die plate 22′ of the second lenticular die 20′. With reference to the embodiments shown in FIGS. 7 and 8, one will appreciate that the height, or rather thickness, of the stacked plates, can vary, preferably being about 5 to 6 inches high and accommodating between 1 and about 20 sheets at a time. The thickness of stacked die plates is limited by the heat transfer ability so that appropriate lenticules can be generated. The thickness of a book (a stacked collection of die plates) can be between about 1-20, more preferably about 3-9 and at least about 5, in order to make such procedures economically feasible. Other possible limitations on the thickness/height of plates is the machinery used and the weights involved. One of skill will endeavor to maintain a stable engraved plate without warping and that holds up well to the heat and machinery environments experienced when using the present invention. The stacked plates can be stacked without chrome in between in some embodiments. In other words, in some embodiments, the die plates 22 can be stacked with just plastic sheets therebetween.

For clarity purposes, the following list of components shown in the drawings and associated numbering is provided herein:

| Number | Component |
|---|---|
| 10 | lenticular optical system |
| 12 | substrate |
| 14 | lens body |
| 16 | printed image |
| 18 | lenticular lens |
| 20 | lenticular die |
| 22 | die plate |
| 24 | punch plate |
| 26 | lenticular grooves |
| 28 | registration pin |
| 30 | pin cavity |
| 34 | pin aperture |
| 36 | lens sheet |
| 38 | lenticular product |
| 40 | registration hole |
| 42 | print sheet |
| 44 | lands |
| 46 | magnetic strip sheet |
| 48 | guide rails |
| 50 | gripper component |
| 52 | lenticular die assembly |
| 54 | common die pin |

While various embodiments of the present invention have been shown and described in detail, it is apparent that modifications and adaptations of those embodiments will occur to those skilled in the art. However, it is to be expressly understood that such modifications and adaptations are within the scope and spirit of the present invention as set forth in the following claims.

What is claimed is:

1. An apparatus for making a lenticular product from a plurality of sheet materials, comprising:
(a) a first plate having a plurality of lens grooves and a plurality of registration pins or guides;
(b) a second plate mounted for alignment relative to said first plate, whereby said first plate and said second plate can be movably positioned for exerting a force therebetween, wherein said force is used for forming lenticules on a first side of a first material positioned between said first and second plates;
(c) one or more alignment members for performing an alignment, relative to at least of one of said first and second plates, at least one of:
(i) said first material for thereby providing a predetermined image on an opposite side of said first material, and
(ii) when said first material is not aligned, a second material is provided for aligning, wherein said second material includes a predetermined image thereon, said first material being between said first plate and said second material;
wherein said alignment remains in effect during the exerting of said force for thereby forming said lenticules using said force.

2. The apparatus as claimed in claim 1, wherein said first plate further comprises a plurality of pin cavities under said plurality of registration pins or guides for correspondingly receiving said plurality of registration pins or guides, wherein said registration pins are included in said alignment members.

3. The apparatus as claimed in claim 2, wherein a biasing means is provided in said pin cavities behind said registration pins or guides.

4. The apparatus as claimed in claim 1, wherein said second plate further comprises a plurality of apertures for receiving said registration pins or guides.

5. The apparatus as claimed in claim 1, further comprising a heating element in operative relationship with an element selected from the group consisting of said first plate, said second plate, or both said first plate and said second plate.

6. The apparatus as claimed in claim 1, further comprising a cooling element in operative relationship with an element selected from the group consisting of said first plate, said second plate, or both said first plate and said second plate.

7. The apparatus as claimed in claim 1, wherein said first plate or said second plate comprises beryllium copper.

8. The apparatus as claimed in claim 1, wherein said second plate or said first plate comprises chrome plated steel.

9. The apparatus as claimed in claim 1, wherein said first plate further comprises a plurality of substantially flat areas adjacent to selected portions of said lens grooves.

10. A method of forming a lenticular product from a plurality of sheet materials, comprising the steps of:
(a) placing a first sheet material on a first plate of a lenticular forming die, said first plate having a plurality of lens grooves and a plurality of registration pins or guides;
(b) placing a second sheet material over at least a portion of said first sheet material on said first plate, said second sheet material having a plurality of registration holes and an image printed on one side, said second sheet placed on said first plate such that said registration pins or guides are received into said second sheet registration holes to provide said second sheet in a predetermined alignment;
(c) moving at least one of a second plate of said lenticular forming die and said first plate toward the other with said first and second sheet materials therebetween; and
(d) with said second sheet material in said predetermined alignment, heating said first sheet and said second sheet, while retained between said first and second plates, to a sufficient temperature for a period of time to fuse said first sheet with said second sheet and to form a plurality of lenticular lenses on said first sheet.

11. The method as claimed in claim 10, wherein said image includes a plurality of registration marks in a predetermined relationship with said image.

12. The method as claimed in claim 11, further comprising the step of removing a portion of said second sheet comprising said plurality of registration marks to provide said plurality of registration holes in said second sheet.

13. The method as claimed in claim 10, further comprising the step of:
following step (b), placing a third sheet over at least a portion of either said first sheet material, said second sheet material, or both said first sheet material and said second sheet material, on said first plate.

14. The method as claimed in claim 13, wherein said third sheet includes a plurality of magnetic strips and a plurality of registration holes in a predetermined relationship with said magnetic strips.

15. The method as claimed in claim 14, wherein said plurality of registration pins or guides are received into said plurality of registration holes of said third sheet.

16. The method as claimed in claim 10, wherein said temperature is between about 150° F. and about 500° F.

17. The method as claimed in claim 10, wherein said temperature is between about 250° F. and about 350° F.

18. The method as claimed in claim 10, wherein said temperature is about 320° F.

19. The method as claimed in claim 10, wherein said period of time is between about 1 minute and about 15 minutes.

20. The method as claimed in claim 10, wherein said period of time is between about 5 minutes and about 12 minutes.

21. The method as claimed in claim 10, wherein said period of time is about 10 minutes.

22. The method as claimed in claim 10, wherein said first sheet and said second sheet are selected from the group consisting of polyvinyl chloride, polyvinyl chloride acetate, polyester, polyethylene, and polycarbonate.

23. The method as claimed in claim 10, wherein said first sheet and said second sheet are comprised of polyvinyl chloride.

24. The method as claimed in claim 10, wherein said first sheet and said second sheet are comprised of Mirrex 1025.

25. A method of forming a lenticular product from a sheet material, comprising the steps of:
(a) placing a first sheet material on a first plate of a lenticular forming die, said first sheet material having an image printed on one side and a plurality of registration holes, said first plate having a plurality of lens grooves and a plurality of registration pins or guides, said first sheet material placed in a predetermined position onto said first plate such that said registration pins or guides are received into said registration holes;
(b) contacting a second plate of said lenticular forming die to an opposite side of said first sheet material while said first sheet material remains effectively in said predetermined position; and
(c) heating said first sheet, during said step of contacting, to a sufficient temperature for a period of time to form a plurality of lenticular lenses on said first sheet that have a desired alignment with corresponding portions of said image.

26. The method as claimed in claim 25, wherein said image includes a plurality of registration marks in a predetermined relationship with said image.

27. The method as claimed in claim 26, further comprising the step of removing a portion of said first sheet comprising said plurality registration marks to provide said plurality of registration holes in said first sheet.

28. The method as claimed in claim 25, further comprising the step of:
following step (a), placing a second sheet over at least a portion of said first sheet material on said first plate.

29. The method as claimed in claim 28, wherein said second sheet includes a plurality of magnetic strips and a plurality of registration holes in a predetermined relationship with said magnetic strips.

30. The method as claimed in claim 29, wherein said plurality of registration pins or guides are received into said plurality of registration holes of said second sheet.

31. The method as claimed in claim 25, wherein said temperature is between about 150° F. and about 500° F.

32. The method as claimed in claim 25, wherein said temperature is between about 250° F. and about 350° F.

33. The method as claimed in claim 25, wherein said temperature is about 320° F.

34. The method as claimed in claim 25, wherein said period of time is between about 1 minute and about 15 minutes.

35. The method as claimed in claim 25, wherein said period of time is between about 5 minutes and about 12 minutes.

36. The method as claimed in claim 25, wherein said period of time is about 10 minutes.

37. The method as claimed in claim 25, wherein said first sheet is selected from the group consisting of polyvinyl chloride, polyvinyl chloride acetate, polyester, polyethylene, and polycarbonate.

38. The method as claimed in claim 34, wherein said first sheet is comprised of polyvinyl chloride.

39. The method as claimed in claim 35, wherein said first sheet is comprised of Mirrex 1025 or similar material having substantially similar vicat and/or phase change, fusion/bonding capabilities.

40. A lenticular product manufactured by a method comprising:
(a) placing a first sheet material on a first plate of a lenticular forming die, said first plate having a plurality of lens grooves and a plurality of registration pins or guides;
(b) placing a second sheet material over at least a portion of said first sheet material on said first plate, said second sheet material having a plurality of registration holes and an image printed on one side, said second sheet placed on said first plate such that said registration pins or guides are received into said second sheet registration holes for providing an alignment of said second sheet material;
(c) moving a second plate of said lenticular forming die and said first plate together while said first and second sheet material are therebetween and said second sheet material is substantially in said alignment; and
(d) heating said first sheet and said second sheet to a sufficient temperature for a period of time to fuse said first sheet with said second sheet and to form a plurality of lenticular lenses on said first sheet.

41. An apparatus for making a lenticular product from a plurality of sheet materials, comprising:
a plurality of pin cavities under said plurality of registration pins or guides for correspondingly receiving said plurality of registration pins or guides;
a biasing means is provided in said pin cavities behind said registration pins or guides, wherein said second plate further comprises a plurality of apertures for receiving said registration pins or guides;
a heating element in operative relationship with an element selected from the group consisting of said first plate, said second plate, or both said first plate and said second plate;
a cooling element in operative relationship with an element selected from the group consisting of said first plate, said second plate, or both said first plate and said second plate; and
wherein said first plate or said second plate comprises either beryllium copper or chrome plated steel and wherein said first plate further comprises a plurality of substantially flat areas adjacent to selected portions of said lens grooves.

42. A method of forming a lenticular product, comprising the steps of:
(a) aligning at least one sheet material with one or more alignment members for obtaining a predetermined alignment, wherein said at least one sheet material includes at least one of:
(i) a first material for thereby providing a predetermined image on an opposite side of said first material, wherein said first material includes a deformable surface for providing a lenticular lens array thereon, and
(ii) when said first material is not aligned, a second material, wherein said second material includes a predetermined image, said second material being in contact with said first material;
(b) moving a first and second pressing portions together with said at least one sheet material in said predetermined alignment between said pressing portions, wherein said first pressing portion includes a plurality of lens grooves; and
(c) providing, while said at least one sheet material is retained between said first and second pressing portions, one or more predetermined deforming stimuli to said at least one sheet material, wherein said lenticular lens array is formed on said deformable surface by said plurality of lens grooves thereby obtaining said lenticular product.

43. The method of claim 40, wherein said one or more predetermined deforming stimuli includes one of: a pressure and a temperature effective for deforming said deformable surface.

44. The method of claim 40, wherein said second material is attached to a surface of said first material opposite to said deformable surface.
